(19) United States
(12) Patent Application Publication
(10) Pub. No.: US 2007/0090131 A1
(43) Pub. Date: Apr. 26, 2007

(54) Cosmetic container

(76) Inventor: Kuo-Chung Fang, Tainan Hsien (TW)

Correspondence Address: BANNER & WITCOFF, LTD., 1100 13th STREET, N.W., SUITE 1200, WASHINGTON, DC, 20005-4051, US

(21) Appl. No.: 11/549,358

(22) Filed: Oct. 13, 2006

(30) Foreign Application Priority Data
Oct. 25, 2005 (TW) 094218433

(51) Int. Cl. G01F 11/00

(52) U.S. Cl. 222/386

(57) ABSTRACT

A cosmetic container includes: a container body including a cylindrical portion having a first open end that defines a first opening and a second open end that defines a second opening, and a funnel-shaped portion extending and reduced in cross-section from the cylindrical portion, the cylindrical portion and the funnel-shaped portion cooperatively defining an inner space; a plunger unit received movably in the inner space through the second opening in the cylindrical portion of the container body; and a cap covering the first opening in the cylindrical portion of the container body when operated in a non-use state, and received in the inner space through the second opening in the cylindrical portion of the container body for pushing the plunger unit toward the first open end of the cylindrical portion of the container body when operated in a state of use.

### CROSS-REFERENCE TO RELATED APPLICATION

This application claims priority of Taiwanese application no. 094218433, filed on Oct. 25, 2005.

### BACKGROUND OF THE INVENTION

1. Field of the Invention

This invention relates to a container, more particularly to a cosmetic container.

2. Description of the Related Art

A container for cosmetics, e.g., lotion, facial cleaner, shampoo, etc., is generally designed to have a pressing device connected to a reservoir body, and a piston unit mounted in the reservoir body. Upon pressing a head of the pressing device, the piston unit is pushed toward an opening in the reservoir body so as to squeeze out the cosmetics contained in the reservoir body. However, such a container has the following disadvantages. First, since many parts (e.g., a spring, valves, etc.) are needed for forming the pressing device, the structure of the pressing device is complicated. Moreover, packaging of the container is required to be conducted under a high pressure environment. As a consequence, production cost for the container is increased. In addition, because of different materials for different parts (e.g., metallic spring, rubber O-ring, etc.), recycling of the container is more complicated, and the recycling cost is increased accordingly. The type of the product contained in the container is also limited, i.e., the container is only suitable for a liquid product.

Therefore, there is a need in the art to provide a cosmetic container that has advantages of simple structure, reduced manufacturing and recycling costs, and easy-to-use.

### SUMMARY OF THE INVENTION

Therefore, the object of the present invention is to provide a cosmetic container that can overcome the aforesaid drawbacks of the prior art.

According to this invention, a cosmetic container includes: a container body including a cylindrical portion having a first open end that defines a first opening and a second open end that defines a second opening, and a funnel-shaped portion extending and reduced in cross-section from the cylindrical portion, the cylindrical portion and the funnel-shaped portion cooperatively defining an inner space; a plunger unit received movably in the inner space through the second opening in the cylindrical portion of the container body; and a cap covering the first opening in the cylindrical portion of the container body when operated in a non-use state, and received in the inner space through the second opening in the cylindrical portion of the container body for pushing the plunger unit toward the first open end of the cylindrical portion of the container body when operated in a state of use.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is an exploded perspective view of the preferred embodiment of a cosmetic container according to this invention;

FIG. 2 is a schematic cross-sectional view showing the cosmetic container of FIG. 1 in a non-use state; and

FIG. 3 is a schematic cross-sectional view showing the cosmetic container of FIG. 1 in a state of use.

### DETAILED DESCRIPTION OF THE PREFERRED EMBODIMENT

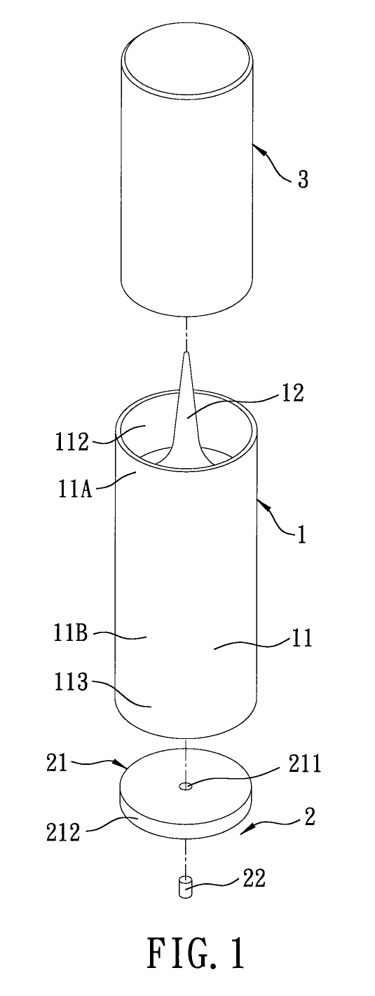

Referring to FIG. 1, the preferred embodiment of a cosmetic container according to the present invention is shown to include a container body 1, a plunger unit 2, and a cap 3.

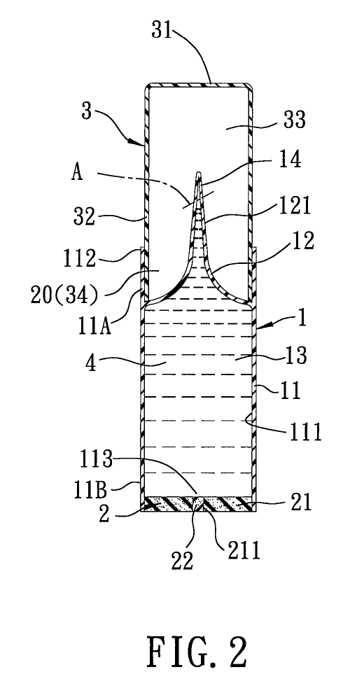

As shown in FIGS. 1 and 2, the container body 1 includes a cylindrical portion 11 having an inner surface 111, a first open end 11A that defines a first opening 112 and a second open end 11B that defines a second opening 113, and a funnel-shaped portion 12 extending and reduced in cross-section from the cylindrical portion 11 and having an outer surface 121 that cooperates with the inner surface 111 of the cylindrical portion 11 to define a cap-inserting space 20 therebetween. The cylindrical portion 11 and the funnel-shaped portion 12 cooperatively define an inner space 13. The container body 1 of this invention can be integrally formed of polypropylene or polyethylene terephthalate (PET) in the form of a single piece.

The plunger unit 2 is used to seal the second opening 113, and is received movably in the inner space 13 through the second opening 113 in the cylindrical portion 11 of the container body 1. The plunger unit 2 includes a disc plate 21 having a through-hole 211 and an outer peripheral surface 212, and a plug 22 for blocking the through-hole 211 in the disc plate 21. The outer peripheral surface 212 of the disc plate 21 is in sliding contact with the inner surface 111 of the cylindrical portion 11.

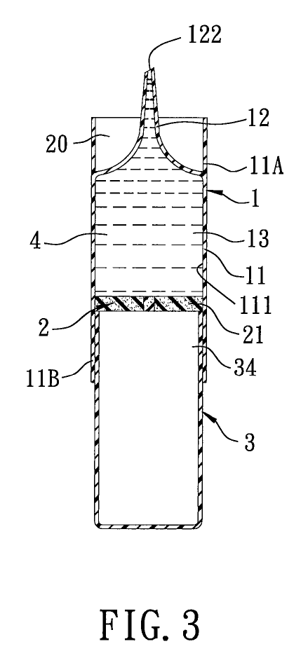

The cap 3 is cylindrical in shape, and has an outer surface 31 that is in sliding contact with the inner surface 111 of the cylindrical portion 11, an inner surface 32 that defines an accommodating space 33 therein, and an open end portion 34. When operated in a non-use state (see FIG. 2), the open end portion 34 of the cap 3 is received in the cap-inserting space 20 so as to cover the first opening 112 in the cylindrical portion 11 of the container body 1, and the funnel-shaped portion 12 of the container body 1 is received in the accommodating space 33 in the cap 3. When operated in a state of use (see FIG. 3), the open end portion 34 of the cap 3 is inserted into the inner space 13 through the second opening 113 in the cylindrical portion 11 of the container body 1 for pushing the plunger unit 2 toward the first open end 11A of the cylindrical portion 11 of the container body 1 so as to squeeze out cosmetics 4 contained in the inner space 13 in the container body 1. Preferably, the cap 3 has a length greater than that of the cylindrical portion 11 of the container body 1 in order to squeeze out the cosmetics 4 completely.

During packaging, the cosmetics 4 is filled into the inner space 13 in the container body 1. The disc plate 21 of the plunger unit 2 is then inserted into the inner space 13 through the second opening 113 of the cylindrical portion 11. The air in the inner space 13 flows out through the through-hole 211 during insertion of the disc plate 21 into the inner space 13. When the disc plate 21 contacts the cosmetics 4, the plug 22 is subsequently inserted into the through-hole 211 to prevent the cosmetics 4 from leaking through the through-hole 211.

When used for the first time, the cap 3 is removed and a tip 14 of the funnel-shaped portion 12 is cut along a cutting line (A) (see FIG. 2) so as to form an opening 122 in the funnel-shaped portion 12 (see FIG. 3). As described above, the open end portion 34 of the cap 3 is inserted into the inner space 13 through the second opening 113 of the cylindrical portion 11 of the container body 1 to push the plunger unit 2 so as to squeeze out cosmetics 4 through the opening 122 in the funnel-shaped portion 12.

It should be noted herein that the shapes of the container body 1, the plunger unit 2, and the cap 3 can vary based on actual requirements. The materials for the container body 1, the plunger unit 2, and the cap 3 can be the same so as to simplify the recycling procedure.

According to the present invention, the cosmetic container has a simple structure and the parts thereof can be made from the same material. Therefore, the manufacturing and recycling costs can be reduced. Moreover, the cosmetic container of this invention is not limited to a specific type of cosmetics and can be used for liquid, cream, and ointment cosmetics.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A cosmetic container comprising:
a container body including a cylindrical portion having a first open end that defines a first opening and a second open end that defines a second opening, and a funnel-shaped portion extending and reduced in cross-section from said cylindrical portion, said cylindrical portion and said funnel-shaped portion cooperatively defining an inner space;
a plunger unit received movably in said inner space through said second opening in said cylindrical portion of said container body; and
a cap covering said first opening in said cylindrical portion of said container body when operated in a non-use state, and received in said inner space through said second opening in said cylindrical portion of said container body for pushing said plunger unit toward said first open end of said cylindrical portion of said container body when operated in a state of use.

2. The cosmetic container of claim 1, wherein said cap is cylindrical in shape and has an outer surface, said cylindrical portion of said container body having an inner surface that is in sliding contact with said outer surface of said cap when said cap is operated in the non-use state and the state of use.

3. The cosmetic container of claim 2, wherein said funnel-shaped portion has an outer surface that cooperates with said inner surface of said cylindrical portion to define a cap-inserting space therebetween, said cap defining an accommodating space therein and having an open end portion that is received in said cap-inserting space when said cap is operated in the non-use state, said funnel-shaped portion of said container body being received in said accommodating space in said cap when said cap is operated in the non-use state.

4. The cosmetic container of claim 1, wherein said plunger unit includes a disc plate having a through-hole and an outer peripheral surface, and a plug for blocking said through-hole in said disc plate, said outer peripheral surface of said disc plate being in sliding contact with said cylindrical portion of said container body.
